(19) United States
(12) Patent Application Publication
(10) Pub. No.: US 2017/0328294 A1
(43) Pub. Date: Nov. 16, 2017

(54) METHODS AND SYSTEMS FOR CATALYST HEALTH MONITORING

(71) Applicants: Ford Global Technologies, LLC, Dearborn, MI (US); THE REGENTS OF THE UNIVERSITY OF MICHIGAN, Ann Arbor, MI (US)

(72) Inventors: Tomas Poloni, Ann Arbor, MI (US); Pankaj Kumar, Dearborn, MI (US); Imad Hassan Makki, Dearborn Heights, MI (US)

(21) Appl. No.: 15/151,386

(22) Filed: May 10, 2016

(51) Int. Cl. F02D 41/26; F01N 11/00; F02D 41/02

(52) U.S. Cl. CPC F02D 41/263; F02D 41/0235; F01N 11/007; F01N 2550/03

(57) ABSTRACT

Methods and systems are provided for continually monitoring a functionality of an exhaust catalyst based on roll-down of a monotonically decreasing catalyst activity parameter representing catalyst storage capacity. Catalyst degradation may be indicated responsive to the estimate of catalyst storage capacity lowering below a threshold. Engine operating parameters may be adjusted based on a current level of catalyst storage capacity.

### FIELD

The present description relates generally to methods and systems for monitoring an efficiency of a catalyst.

### BACKGROUND/SUMMARY

Emission control devices, such as a three-way catalyst, coupled to an exhaust of an internal combustion engine reduce combustion by-products such as carbon monoxide, hydrocarbons, and oxides of nitrogen. To reduce emissions, catalyst health monitoring methods may be used to detect degradation of the emission control device as well as to determine if the device needs replacement. Reliable catalyst health monitoring may reduce costs by decreasing erroneous characterization of a functional catalyst as an expended catalyst, as well as reducing emissions by decreasing erroneous characterization of a degraded catalyst as a functional catalyst.

Various approaches for catalyst health monitoring have been developed. One example approach shown by Shi et al. in U.S. Pat. No. 6,694,243 discloses a method for monitoring catalyst health based on a measured oxygen storage capacity (OSC) of the catalyst. A modelled OSC may be determined based on engine operating parameters. The modelled OSC is compared to the measured OSC of the catalyst to determine a normalized OSC. The normalized OSC is then compared to a threshold value in order to determine the health of the catalyst.

However, the inventors herein have recognized potential issues with such systems. As one example, the approach may be able to determine if a catalyst is fully functional or fully degraded but may not be able to identify the functionality of the catalyst at any intermediate stage (such as where the catalyst is partially functional, and to what degree the catalyst is partially functional). That is, the above approach may be unable to monitor a gradual change (e.g., deterioration) in catalyst health over the lifetime of the catalyst. By comparing catalyst oxygen storage capacity to a fixed threshold value, stage-wise changes in catalyst functionality may not be learned and thereby engine operations may not be suitably adjusted. As such, the catalyst functionality deteriorates based on usage as well as time. Consequently, there may be associated inaccuracies in the on-board diagnostics if compensative measures accounting for current catalyst state are not undertaken. Other approaches for catalyst health monitoring may involve estimating catalyst functionality during deceleration fuel shut off (DFSO) events, however such events may not occur frequently enough over a drive cycle, thereby making catalyst health monitoring challenging.

The inventors herein have identified an approach by which the issues described above may be at least partly addressed. One example method includes adjusting engine fuel injection responsive to sensor feedback and a first estimate of catalyst storage capacity determined during engine operation, the first estimate increased and decreased responsive to conditions; and indicating catalyst degradation responsive to a second estimate of catalyst storage capacity estimated during engine operation, the second estimate only decreased responsive to conditions. In this way, a continually decreasing catalyst activity parameter may be used to track catalyst functionality over the lifetime of the catalyst and accordingly adjust engine operating parameters.

As one example, a catalyst activity parameter (AC) may be defined as a parameter depicting a current level of storage capacity (functionality) of a three-way catalyst. As such, for a new catalyst installed in a vehicle, the AC parameter may be set to a maximum value (e.g., 1.0). For catalyst health monitoring, the AC parameter may be decreased monotonically whereas the actual catalyst storage capacity may both increase and decrease based on catalyst operating conditions. Two model-based filters may be used to monitor the catalyst health. Specifically, the two model-based filter may be defined (e.g., filter A and filter B) and each filter may be assigned a pre-set AC value. The AC parameter assigned to filter A may have the maximum possible value (e.g., 1.0 when the catalyst is new) while filter B may be assigned an AC parameter corresponding to a first level of catalyst degradation (e.g., less than 1.0, such as 0.8) representative of a first catalyst state that is one level below a fully functional catalyst state. Simultaneously, air-fuel ratio may be estimated over a finite time window via an exhaust gas oxygen sensor (such as a UEGO or HEGO sensor) coupled to an exhaust passage upstream or downstream of the catalyst. An air-fuel ratio expected based on the AC parameters corresponding to each of filters A and B may be compared to the estimated air-fuel ratio and an error (e.g., a normalized mean-square error or NMSE) may be estimated for each of the two filters. If the NMSE for filter A is lower than or equal to the NMSE for filter B, it may be inferred that the AC parameter for filter A more accurately represents the current storage capacity of the catalyst and engine operating parameters as well as initiation of on-board diagnostic (OBD) routines may be adjusted accordingly. If the NMSE for filter B is lower, it may be inferred that the AC parameter for filter B more accurately represents the current storage capacity of the catalyst, and that the catalyst storage capacity has degraded to the catalyst degradation level represented by filter B. Responsive to the lower error at filter B, the AC parameters of the two filters may be updated using a roll-down methodology. Therein, the AC parameter for filter A is lowered to the preset AC parameter of filter B while the AC parameter for filter B is lowered to a second level of catalyst degradation (e.g., less than 0.8, such as 0.7) representative of a second catalyst state that is one level below the first catalyst state. In addition, engine operating parameters such as fueling, as well as initiation of OBD routines may be adjusted based on the updated functionality of the catalyst. In one example, fueling may be increased/decreased and initiation of OBD routines may be delayed based on the updated catalyst functionality. The updating of the filter AC parameters may be repeated iteratively responsive to a difference in the expected air-fuel ratio at each filter from the actual (estimated) air-fuel ratio until filter A is lowered to a threshold AC value (e.g., a minimum permissible value). Once the AC parameter for filter A reaches the threshold value, degradation of the catalyst may be indicated and catalyst replacement may be requested. Once the catalyst is replaced, the AC parameter for filter A may be reset and rolled-down method for catalyst health monitoring may be resumed.

In this way, by using a plurality of model-based filters to monitor catalyst health, catalyst functionality may be continuously tracked and intermediate stages of a catalyst's health may be determined. By more accurately determining the functionality of the catalyst at any given time, including a state of partial activity as well as a degree of loss in activity, engine operating parameters may be accordingly adjusted to improve fuel consumption and emissions quality. In addition, initiation of on-board diagnostic routines may be adjusted taking into account a current state of the catalyst, allowing for an improvement in the completion rate of the routines. The technical effect of using a model-based roll-down methodology for catalyst health monitoring is that catalyst activity may be continually tracked without having to wait for specific engine conditions, such a DFSO event. In addition, the approach may have a lower computational demand.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example embodiment of an engine system including a catalyst coupled to the exhaust passage.

FIG. 2 shows a flow chart illustrating an example method that may be implemented for updating a first and a second estimate of catalyst storage capacity.

FIG. 3 shows a flow chart illustrating an example method that may be implemented for continually monitoring an efficiency of the catalyst of FIG. 1.

FIG. 4 shows an example monitoring of catalyst health.

FIG. 5 shows an example of catalyst health monitoring based on a roll-down methodology.

### DETAILED DESCRIPTION

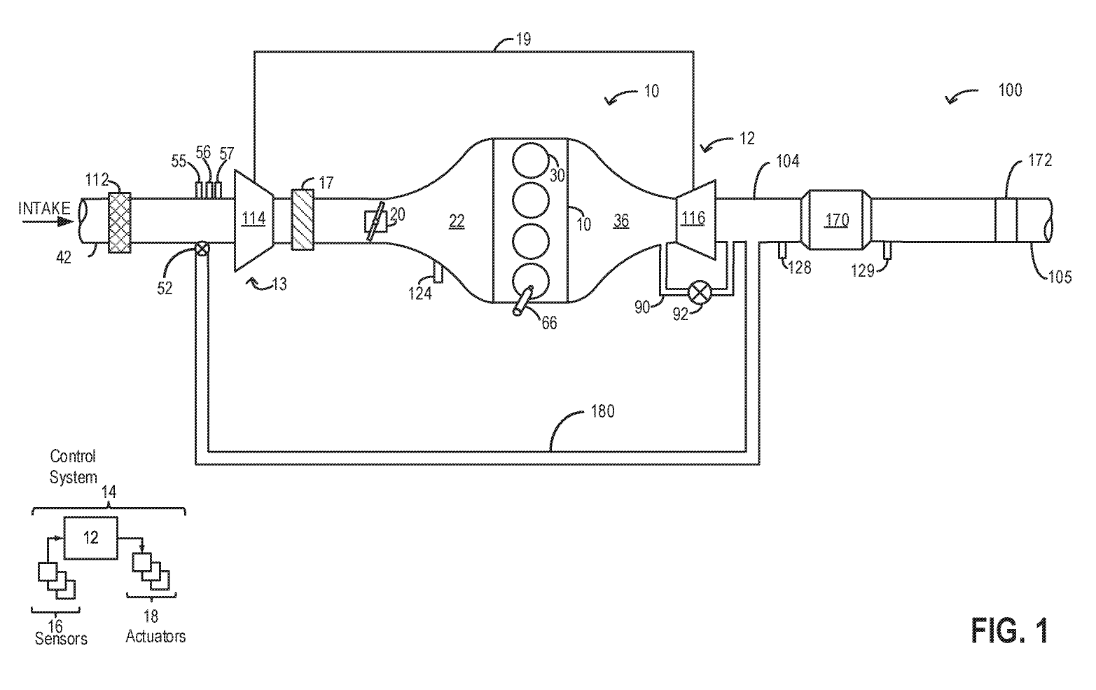

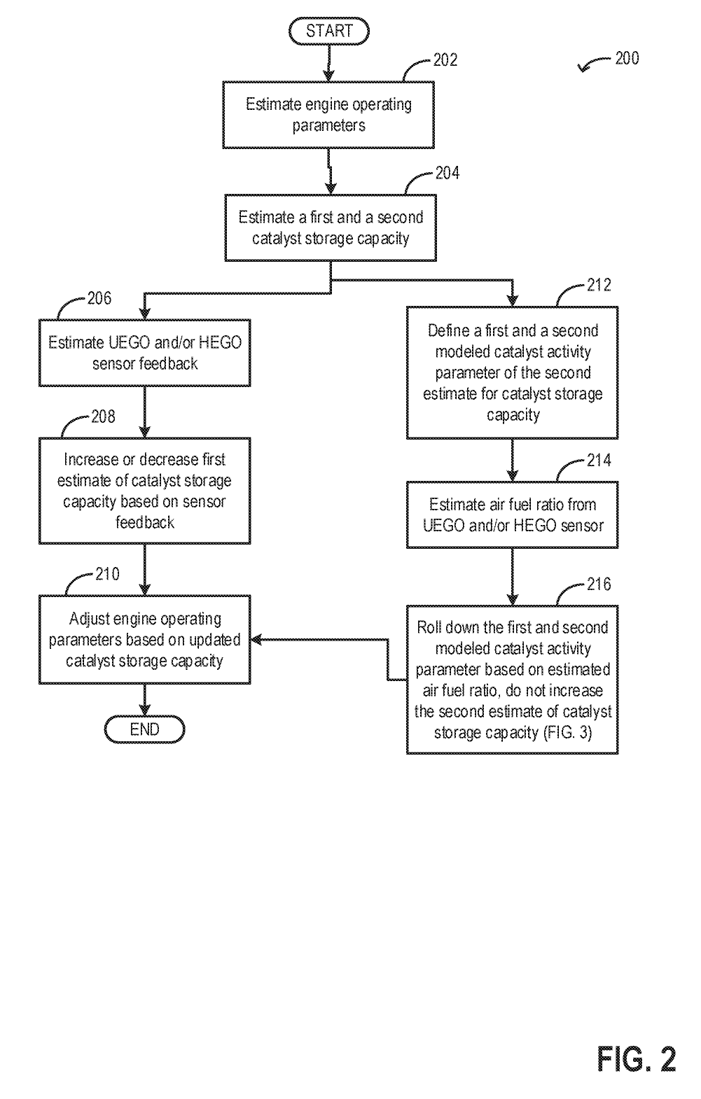

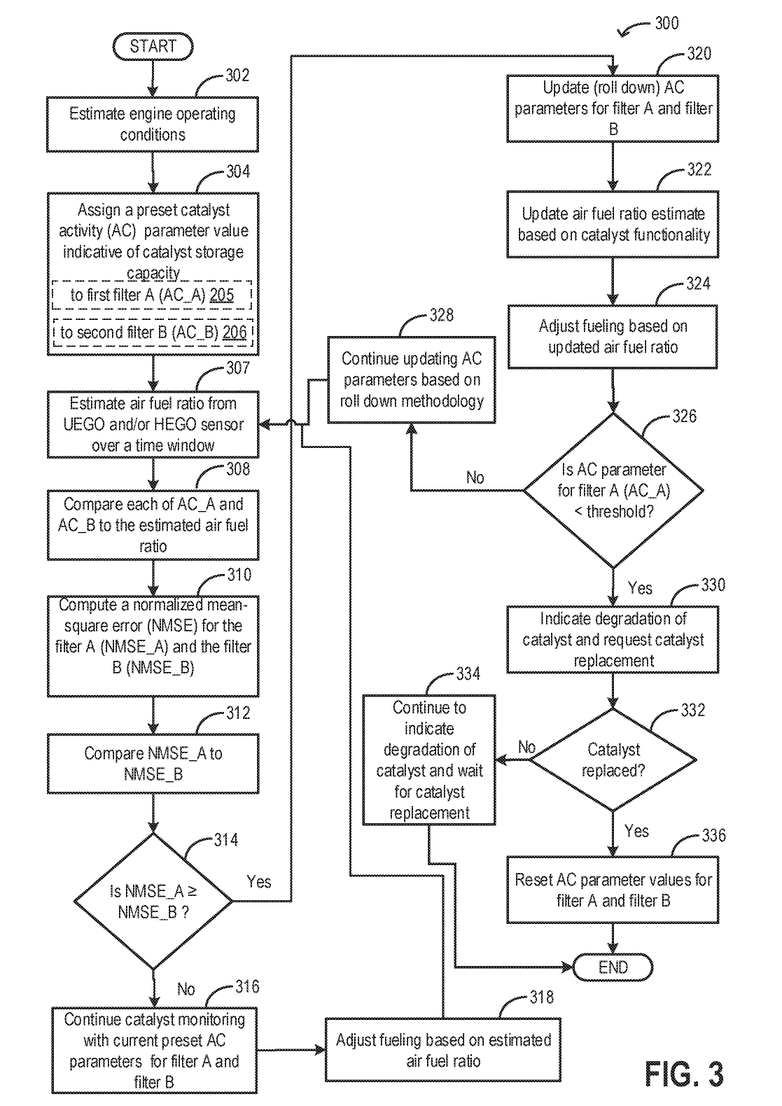

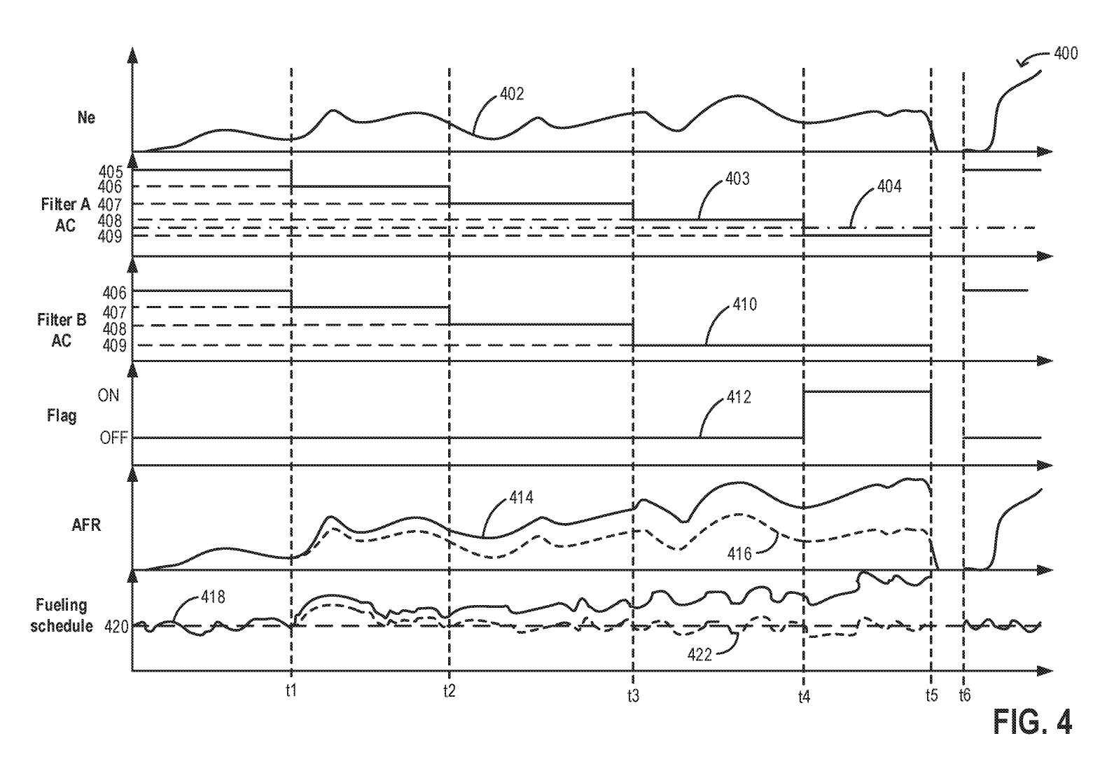

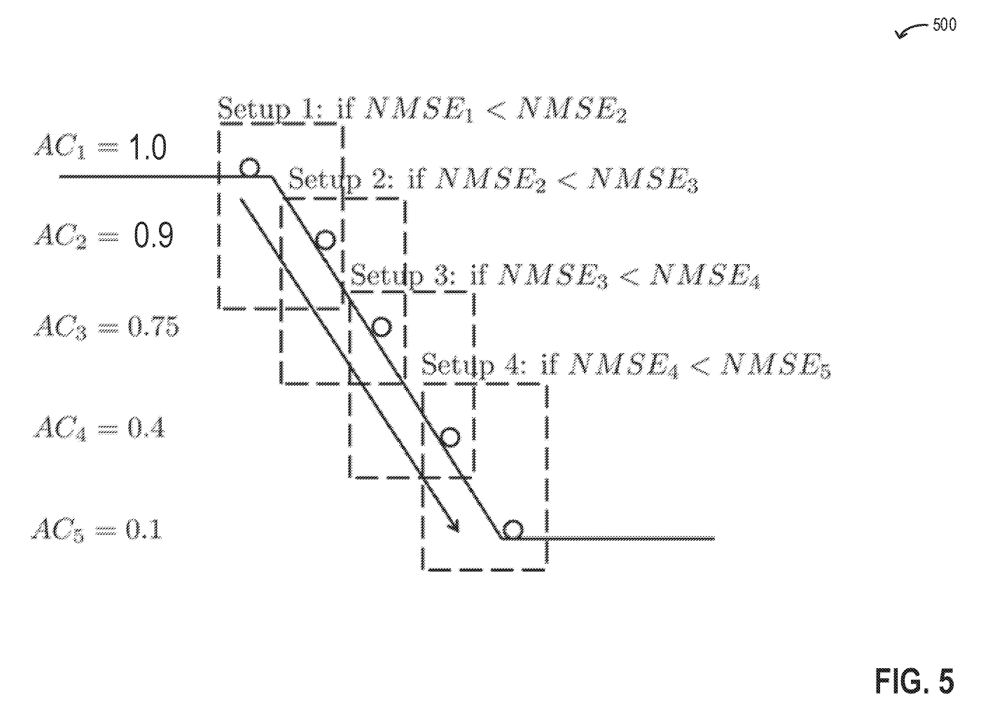

The following description relates to systems and methods for continually monitoring the health of an exhaust catalyst over its lifetime and adjusting engine operating parameters based on a functionality of the catalyst. An example engine system comprising an exhaust catalyst is shown in FIG. 1. An engine controller may be configured to perform control routines, such as the example routines of FIGS. 2 and 3, to update a first and a second modeled estimate of the catalyst's storage capacity based on deviations from an estimated exhaust air-fuel ratio. The controller may also utilize the monotonically decreasing estimate of the catalyst storage capacity to adjust engine operation. An example of catalyst health monitoring using a roll-down methodology is discussed in FIG. 5 and another example of catalyst health monitoring and corresponding engine adjustments are discussed with relation to FIG. 4.

FIG. 1 schematically shows aspects of an example engine system 100 including an engine 10. In the depicted embodiment, engine 10 is a boosted engine coupled to a turbocharger 13 including a compressor 114 driven by a turbine 116. Specifically, fresh air is introduced along intake passage 42 into engine 10 via air cleaner 112 and flows to compressor 114. The compressor may be any suitable intake air compressor, such as a motor-driven or driveshaft-driven supercharger compressor. In engine system 10, the compressor is a turbocharger compressor mechanically coupled to turbine 116 via a shaft 19, the turbine 116 driven by expanding engine exhaust.

As shown in FIG. 1, compressor 114 is coupled, through charge-air cooler (CAC) 17 to throttle valve 20. Throttle valve 20 is coupled to engine intake manifold 22. From the compressor, the compressed air charge flows through the charge-air cooler 17 and the throttle valve to the intake manifold. In the embodiment shown in FIG. 1, the pressure of the air charge within the intake manifold is sensed by manifold air pressure (MAP) sensor 124.

One or more sensors may be coupled to an inlet of compressor 114. For example, a temperature sensor 55 may be coupled to the inlet for estimating a compressor inlet temperature, and a pressure sensor 56 may be coupled to the inlet for estimating a compressor inlet pressure. As another example, a humidity sensor 57 may be coupled to the inlet for estimating a humidity of aircharge entering the compressor. Still other sensors may include, for example, air-fuel ratio sensors, etc. In other examples, one or more of the compressor inlet conditions (such as humidity, temperature, pressure, etc.) may be inferred based on engine operating conditions. In addition, when exhaust gas recirculation (EGR) is enabled, the sensors may estimate a temperature, pressure, humidity, and air-fuel ratio of the aircharge mixture including fresh air, and exhaust residuals received at the compressor inlet.

A wastegate actuator 92 may be actuated open to dump at least some exhaust pressure from upstream of the turbine to a location downstream of the turbine via wastegate 90. By reducing exhaust pressure upstream of the turbine, turbine speed can be reduced, for boost control and/or to reduce compressor surge.

Intake manifold 22 is coupled to a series of combustion chambers 30 through a series of intake valves (not shown). The combustion chambers are further coupled to exhaust manifold 36 via a series of exhaust valves (not shown). In the depicted embodiment, a single exhaust manifold 36 is shown. However, in other embodiments, the exhaust manifold may include a plurality of exhaust manifold sections. Configurations having a plurality of exhaust manifold sections may enable effluent from different combustion chambers to be directed to different locations in the engine system.

In one embodiment, each of the exhaust and intake valves may be electronically actuated or controlled. In another embodiment, each of the exhaust and intake valves may be cam actuated or controlled. Whether electronically actuated or cam actuated, the timing of exhaust and intake valve opening and closure may be adjusted as needed for desired combustion and emissions-control performance.

Combustion chambers 30 may be supplied with one or more fuels, such as gasoline, alcohol fuel blends, diesel, biodiesel, compressed natural gas, etc., via injector 66. Fuel may be supplied to the combustion chambers via direct injection, port injection, throttle valve-body injection, or any combination thereof. In the combustion chambers, combustion may be initiated via spark ignition and/or compression ignition.

As shown in FIG. 1, exhaust from the one or more exhaust manifold sections is directed to turbine 116 to drive the turbine. The combined flow from the turbine and the wastegate then flows through an exhaust after-treatment catalyst 170. One or more exhaust catalysts 170 may be configured to catalytically treat the exhaust flow, and thereby reduce an amount of one or more substances in the exhaust flow. For example, exhaust catalyst 170 may be configured as a NOx trap for trapping NO, from the exhaust flow when the exhaust flow is lean, and to reduce the trapped NO, when the exhaust flow is rich. In other examples, the catalyst 170 may be an SCR catalyst configured to disproportionate NO, or to selectively reduce NO, with the aid of a reducing agent. In still other examples, exhaust catalyst 170 may be configured as an oxidation catalyst or a three-way catalyst for oxidizing residual hydrocarbons and/or carbon monoxide in the exhaust flow. Different exhaust after-treatment catalysts having any of the discussed functionalities may be arranged in wash coats or elsewhere in the exhaust after-treatment stages, either separately or together. In some embodiments, the exhaust after-treatment stages may include a regeneratable soot filter configured to trap and oxidize soot particles in the exhaust flow.

A first exhaust gas sensor 128 may be coupled to the exhaust passage 48 upstream of the catalyst 170. A second exhaust gas sensor 129 may be coupled to the exhaust passage 48 downstream of the catalyst 170. Each of the sensors 128 and 129 may be suitable sensors for providing an indication of exhaust gas air-fuel ratio such as linear oxygen sensors or UEGO (universal or wide-range exhaust gas oxygen), two-state oxygen sensors or EGO, HEGO (heated EGO), a NOx, HC, or CO sensors.

All or part of the treated exhaust from catalyst 170 may be released into the atmosphere via main exhaust passage 102 after passing through a muffler 172. A low pressure exhaust gas recirculation (LP-EGR) passage 180 may route exhaust from the exhaust passage 104 (downstream of the turbine 116) to the intake passage 42 (upstream of the compressor 114). EGR valve 52 may be opened to admit a controlled amount of exhaust gas to the compressor inlet for desirable combustion and emissions control performance. EGR valve 52 may be configured as a continuously variable valve. In an alternate example, however, EGR valve 52 may be configured as an on/off valve. In further embodiments, the engine system may include a high pressure EGR flow path wherein exhaust gas is drawn from upstream of turbine 116 and recirculated to the engine intake manifold, downstream of compressor 114.

One or more sensors may be coupled to EGR passage 180 for providing details regarding the composition and condition of the EGR. For example, a temperature sensor may be provided for determining a temperature of the EGR, a pressure sensor may be provided for determining a pressure of the EGR, a humidity sensor may be provided for determining a humidity or water content of the EGR, and an air-fuel ratio sensor may be provided for estimating an air-fuel ratio of the EGR. Alternatively, EGR conditions may be inferred by the one or more temperature, pressure, humidity, and air-fuel ratio sensors 55-57 coupled to the compressor inlet. In one example, air-fuel ratio sensor 57 is an oxygen sensor.

As such, the functionality of the exhaust catalyst 170 may deteriorate based on usage as well as over time of engine operation. To enable the health of the catalyst to be monitored continually and accurately, a catalyst activity parameter representing a storage capacity (or functionality) of the catalyst may be assigned to the catalyst when new, the parameter then updated during engine operation using a model-based rolling-down method elaborated herein at FIG. 3. Therein, two model-based filters (such as filter A and filter B) may be defined and each filter may be assigned a pre-set AC value. The AC parameter assigned to the first filter (filter A) may be an upper threshold (e.g., a maximum value of 1.0) when a new catalyst is installed in the vehicle while the second filter (filter B) may be assigned a lower AC parameter, such as an AC parameter corresponding to a first level of catalyst degradation. In one example, the first level of catalyst degradation corresponds to a first catalyst state that is one level below a fully functional catalyst state. An expected exhaust air-fuel ratio for each filter may be predicted based on the corresponding AC parameter and compared to an actual exhaust gas air-fuel ratio estimated via one or both of the first and second exhaust gas sensors 128 and 129. Each of the first activity parameter (assigned to filter A) and the second activity parameter (assigned to filter B) may be continually and iteratively updated (specifically rolled down) based on deviations at each filter from the estimated air-fuel ratio, over a time window. As such, the first and second activity parameters are not increased responsive to the comparison. By iteratively updating the catalyst storage capacity, the health of the exhaust catalyst may be tracked in real-time, enabling commensurate engine operating adjustments to be made.

The roll-down methodology may be continued until a rolled-down value of the first activity parameter reaches a threshold, at which point catalyst degradation may be indicated and catalyst replacement may be requested. In response to replacement of the exhaust catalyst, the first activity parameter may be reset to the upper limit of catalyst functionality and the monitoring may be restarted.

Engine system 100 may further include control system 14. Control system 14 is shown receiving information from a plurality of sensors 16 (various examples of which are described herein) and sending control signals to a plurality of actuators 18 (various examples of which are described herein). As one example, sensors 16 may include exhaust gas sensors 128 and 129, MAP sensor 124, exhaust temperature sensor, exhaust pressure sensor, compressor inlet temperature sensor 55, compressor inlet pressure sensor 56, compressor inlet humidity sensor 57, and EGR sensor. Other sensors such as additional pressure, temperature, air-fuel ratio, and composition sensors may be coupled to various locations in engine system 100. The actuators 81 may include, for example, throttle 20, EGR valve 52, wastegate 92, and fuel injector 66. The control system 14 may include a controller 12. The controller 12 may receive input data from the various sensors, process the input data, and trigger various actuators in response to the processed input data based on instruction or code programmed therein corresponding to one or more routines.

For example, based on an air-fuel ratio estimated by one or more or each of the exhaust gas sensors 128 and 129, a catalyst health may be updated. A plurality of engine actuators (e.g., fuel injector 66) may be adjusted based on the updated functionality of the catalyst 170. In another example, based on engine operating conditions and EGR requirements, the controller 12 may regulate the opening EGR valve 52 to draw a desired amount of EGR from the exhaust bypass passage into the engine intake manifold.

FIG. 1 shows an example engine system comprising an exhaust catalyst with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example.

In this way, the system of FIG. 1 provide for an engine system, comprising an exhaust pipe including a three-way catalyst; a first exhaust gas sensor coupled to the exhaust pipe upstream of the three-way catalyst; a second exhaust gas sensor coupled to the exhaust pipe downstream of the three-way catalyst; a fuel injector for injecting fuel into an engine cylinder; and a controller. The controller may be configured with computer readable instructions stored on non-transitory memory for: assigning activity parameters to each of a first filter and a second filter associated with an exhaust catalyst storage capacity; iteratively updating an estimated exhaust catalyst storage capacity based on error associated with each of the first filter and the second filter; and adjusting fuel injection based on the updated estimated exhaust catalyst storage capacity.

FIG. 2 illustrates an example method 200 for updating a catalyst health. The method may update a first and a second modeled estimate of catalyst storage capacity based on deviations from an actual air-fuel ratio estimate. Instructions for carrying out method 200 and the rest of the methods included herein may be executed by a controller based on instructions stored on a memory of the controller and in conjunction with signals received from sensors of the engine system, such as the sensors described above with reference to FIG. 1. The controller may employ engine actuators of the engine system to adjust engine operation, according to the methods described below.

At 202, the routine includes estimating current engine operating parameters including, for example, engine load, engine speed, vehicle speed, exhaust air-fuel ratio, manifold vacuum, throttle position, spark timing, EGR flow, exhaust pressure, etc. Based on the current engine operating conditions, at 204, a first and a second catalyst storage capacity may be estimated. The first estimate of catalyst storage capacity may be utilized for regulating engine operating parameters such as a fueling schedule during engine operation. The second estimate of catalyst storage capacity may be utilized for catalyst health (functionality) monitoring throughout the lifetime of the catalyst. From 204, the routine moves to updating the first estimate via a first set of adjustments and responsive to a first set of conditions (as elaborated at 206-208) while concurrently updating the second estimate via a second set of adjustments (different from the first set of adjustments) and responsive to a second set of conditions (as elaborated at 212-216). The first set of conditions may be non-overlapping or at least partially overlapping with the second set of conditions. The routines may then merge again at 210.

Turning now to the updating of the first estimate, at 206, exhaust gas sensor feedback may be received. For example, exhaust air-fuel ratio may be estimated based on the output of at least one of a first exhaust gas oxygen sensor coupled upstream of the exhaust catalyst (such as a UEGO) and a second exhaust gas oxygen sensor coupled to the exhaust passage downstream of the catalyst (such as a HEGO). Further, the estimated exhaust air-fuel ratio may be based on the output of each of the upstream and the downstream exhaust gas sensor. In one example, the sensors may include exhaust gas sensors 128 and 129 of FIG. 1.

Based on the sensor feedback, at 208, the first estimate of the catalyst storage capacity may be updated. Herein updating the first estimate includes increasing or decreasing the first estimate based on the sensor feedback.

At 210, based on the updated first estimate of the catalyst storage capacity, one or more engine operating parameters may be adjusted. As such, the updated first estimate may represent a current catalyst storage capacity. In one example, a fueling schedule may be adjusted based on the current catalyst storage capacity.

Turning now to the updating of the second estimate, at 212, a first and a second modeled catalyst activity (AC) parameter may be defined for the second estimate of catalyst storage capacity. The first modeled catalyst activity parameter may be initially set to a theoretical upper limit of catalyst functionality (e.g., a normalized value of AC=1), and the second modeled catalyst activity parameter may be initially set to a first level of degradation in catalyst functionality (next reduced level). At 214, exhaust air-fuel ratio may be estimated over a time window based on the output of at least one of a first exhaust gas oxygen sensor coupled upstream of the exhaust catalyst (such as a UEGO) and a second exhaust gas oxygen sensor coupled to the exhaust passage downstream of the catalyst (such as a HEGO). The estimated exhaust air-fuel ratio may be further based on the output of each of the upstream and the downstream exhaust gas sensor. As an example, the sensors may include exhaust gas sensors 128 and 129 of FIG. 1.

At 216, the routine includes rolling down the first and second modeled catalyst activity parameter based on the estimated air-fuel ratio. As elaborated at FIG. 3, the first and the second modeled catalyst activity parameters corresponding to the second estimate of the catalyst storage capacity may be decrease monotonically responsive to engine conditions using a roll-down methodology and may not be increased responsive to any engine condition.

The roll down methodology may include estimating each of a first error between the measured air-fuel ratio and estimated air-fuel ratio based on the first activity parameter and a second error between the measured air-fuel ratio and estimated air-fuel ratio based on the second activity parameter; responsive to the first error lower than the second error, maintaining each of the first activity parameter and the second activity parameter; responsive to the second error lower than the first error, rolling down the first activity parameter to a value of the second activity parameter while rolling down the second activity parameter to a value corresponding to a second level of degradation in catalyst functionality, the second level higher than the first level; and updating the estimated exhaust catalyst storage capacity based on the rolling down of the first activity parameter.

The routine then moves to 210 wherein a plurality of engine operating parameters (such as air-fuel ratio, and fueling schedule) and initialization of on-board diagnostic routines may be adjusted based on the second estimate of catalyst storage capacity. A detailed description of the catalyst health monitoring using the modeled AC parameters is discussed in relation to FIG. 3.

In this way, a first and a second modeled estimate of catalyst storage capacity based on air-fuel ratio estimations may be utilized for scheduling engine operating parameters and for monitoring catalyst health (functionality).

FIG. 3 illustrates an example method 300 for continuous health (functionality) monitoring of an exhaust catalyst (such as a three-way catalyst). The method enables a controller to accurately estimate a current storage capacity of the catalyst at any point over the lifetime of the catalyst. In one example, the method of FIG. 3 may be performed as part of the routine of FIG. 2, such as at step 216.

At 302, the routine includes estimating current engine operating parameters. Parameters assessed may include, for example, engine load, engine speed, vehicle speed, exhaust air-fuel ratio, manifold vacuum, throttle position, spark timing, EGR flow, exhaust pressure, etc.

At 304, a preset catalyst activity (AC) parameter may be assigned to two model-based filters (herein referred to as filter A and filter B). As such, the AC parameter is defined as a parameter depicting a current level of catalyst storage capacity of the exhaust catalyst (which in one example is a three-way catalyst such as catalyst 170 of FIG. 1) and the AC parameter may be used for catalyst health monitoring. In one example, the estimate of catalyst storage capacity utilized for catalyst health monitoring may be the second estimate of catalyst storage capacity as discussed in FIG. 2. For a new catalyst installed in a vehicle, the AC parameter may be set to a maximum value (e.g., 1.0 or higher). For catalyst health monitoring, the AC parameter may only decrease monotonically (and not increase) whereas the actual catalyst storage capacity may both increase and decrease based on engine operations.

At 305, a first AC parameter (AC_A) may be assigned to a first model-based filter A. The first AC parameter assigned to filter A (AC_A) may have the maximum possible value when the catalyst is new, corresponding to a fully functional catalyst (e.g., 1.0 for a new catalyst). At 306, a second AC parameter (AC_B) may be assigned to a second model-based filter B. The second AC parameter assigned to filter B (AC_B) may correspond to a first level of catalyst degradation (e.g., less than 1.0, such as 0.8). The first level of catalyst degradation may be representative of a first catalyst state that is one level below a fully functional catalyst state. Thus, assigning activity parameters to each of the first filter and second filter includes initially assigning a first activity parameter of the first filter to the exhaust catalyst storage capacity corresponding to an upper limit of catalyst functionality, and initially assigning a second activity parameter of the second filter to the exhaust catalyst storage capacity corresponding to a first level of degradation in catalyst functionality.

At 307, exhaust air-fuel ratio may be measured based on the output of at least one of a first exhaust gas oxygen sensor coupled upstream of the exhaust catalyst (such as a UEGO sensor) and a second exhaust gas oxygen sensor coupled to the exhaust passage downstream of the catalyst (such as a HEGO sensor). The air-fuel ratio monitoring may be carried out over a definite time window. In one example, the time window includes 500 samples. The time window may be based on a pre-calibrated value to avoid sharp changes. Estimates from a plurality of exhaust gas sensors (such as exhaust gas sensors 128 and 129 in FIG. 1) over the time window may be used to determine an average air-fuel ratio of the exhaust gas.

At 308, an estimated air-fuel ratio is computed based on the AC parameters corresponding to each of filters A and B. In one example, an air-fuel ratio estimate may be computed for each filter based on the current catalyst functionality as represented by the activity parameters AC_A and AC_B. The measured air-fuel ratio may be compared to the computed (estimated) air-fuel ratios. At 310, based on the comparison between the estimated air-fuel ratios corresponding to the AC parameters and the measured air-fuel ratios, a first normalized mean-square error (NMSE_A) may be computed for filter A, and a second normalized mean-square error (NMSE_B) may be computed for filter B. The normalized mean-square errors represent the difference between the computed estimation of air-fuel ratio (for each filter) and the actual (measured) air-fuel ratio. The smaller the value of the normalized mean-square error, the closer is the computed estimation to the actual measurement. Therefore the filter with the smaller normalized mean-square error has an AC parameter closer to the actual functional state of the catalyst.

At 312, the value of NMSE_A is compared to the value of NMSE_B. At 314, the routine includes determining if NMSE_A is greater than or equal to NMSE_B. If the NMSE for filter A is lower than or equal to the NMSE for filter B, it may be inferred that the AC parameter for filter A more accurately represents the current storage capacity of the catalyst and that the catalyst is fully functional (without any degradation). In addition, at 316, the preset AC parameters assigned for filter A (AC_A) and filter B (AC_B) may not be updated. The AC parameters AC_A and AC_B are continued to be utilized for comparison of the estimated air-fuel ratio with the measured air-fuel ratio for effective catalyst functionality monitoring. Since at this stage there is no indication of catalyst degradation, at 218, engine operations including fueling may be adjusted based on air-fuel ratio estimation carried out via exhaust gas sensors.

If it is determined that NMSE_B is lower than NMSE_A, it may be inferred that the catalyst functionality has decreased to a first lower level which is one level below the initial functionality. In particular, it may be inferred that the current catalyst functionality does not correspond to the fully functional state of AC_A but actually corresponds to the first level of catalyst degradation of AC_B. Responsive to the error of the second filter being smaller than the error of the first filter, at 320, the AC parameters of the two filters are updated based on a roll-down methodology. Following the roll-down methodology, filter A is updated with the preset AC parameter setting of filter B and the filter B may be updated with a AC parameter that is lower (e.g., by one level) than its previous setting, the updated setting corresponding to a second level of catalyst degradation (representative of a second catalyst state that is two levels below a fully functional catalyst state). Further, due to the degraded state of the catalyst, the exhaust air-fuel estimate carried out using AC value corresponding to filter A may not be accurate.

At 322, the exhaust air-fuel ratio may be updated taking into account the current level of catalyst functionality. In one example, due to the degraded state of the catalyst, the exhaust air-fuel ratio estimated by the exhaust gas sensors may be higher than the actual air-fuel ratio. The estimated air-fuel ratio may be adjusted (e.g., with a correction factor) based on the current catalyst functionality. Based on the updated air-fuel ratio, at 324, engine operating parameter including the fueling schedule may be adjusted. In one example, based on the erroneous estimation of the exhaust air-fuel ratio, the fueling may have been scheduled to be richer than stoichiometry. However, by utilizing the updated air-fuel ratio, the fueling schedule may be adjusted accordingly to maintain fueling at a stoichiometric level. The controller may also send signals to a plurality of other engine actuators to adjust engine operations based on the current level of catalyst functionality.

In addition, the schedule of one or more on-board diagnostic (OBD) routines may be adjusted based on the updated functionality of the catalyst. As one example, the initiation of an OBD routine may be delayed responsive to the updated functionality of the catalyst. For example, the light off time may increase as the catalyst ages. This may in turn increase the time it takes for the oxygen sensors to warm up and as such may overall delay the OBD routine for some functionality.

At 326, the routine includes determining if the current AC parameter for filter A (the current value of AC_A) is lower than a threshold AC parameter. The threshold AC parameter may correspond to a minimum permissible value of AC parameter indicative of a degraded catalyst. If it is determined that the current AC_A value is higher than the threshold AC parameter, at 328, the AC parameters corresponding to filter A and filter B are continued to be updated based on the roll-down methodology. The updating of the filer AC parameters may be repeated iteratively responsive to a difference in the expected air-fuel ratio at each filter from the actual (estimated) air-fuel ratio until filter A is lowered to a threshold AC value (e.g., a minimum permissible value). Each time, after a comparison between NMSE_A and NMSE_B, if NMSE_A is lower than NMSE_B, current AC parameters AC_A and AC_B (without any update) are continued to be utilized for comparison with the estimated air-fuel ratio for effective catalyst functionality monitoring. If NMSE_B is lower than NMSE_A, filter A may again be updated with the preset AC parameter setting of filter B and the filter B may be updated with a AC parameter that is one level below its previous setting corresponding to a lower level of catalyst degradation. The roll-down methodology is repeated iteratively to continually monitor each stage of catalyst degradation. Engine operating parameters and initiation of on-board diagnostics may be correspondingly adjusted based on the current catalyst functionality.

If it is determined (at 326) that AC_A is lower than the threshold AC parameter, it may be inferred that the catalyst is degraded. At 330, degradation of the catalyst may be indicated. The indicating may include setting a flag or a diagnostic code, or activating a malfunction indicator lamp in order to notify the vehicle operator that the catalyst is degraded and have to be replaced. In response to the indication of catalyst degradation, the controller may adjust the operation of one or more engine actuators to adjust engine operation. As one example, in response to the indication of catalyst degradation, the controller may adjust the fueling schedule, limit an engine load (e.g., by reducing an opening of an intake throttle), limit an engine torque output, and/or reduce boost pressure (e.g., by opening a wastegate coupled to an exhaust turbine or a bypass valve coupled to an intake compressor).

At 332, the routine includes determining if the degraded catalyst has been replaced. If it is determined that the catalyst has not yet been replaced, at 334, the indication of catalyst degradation may be continued while waiting for catalyst replacement by the user. During this time, the engine operating parameters and on-board diagnostics may be adjusted based on the degraded state of the catalyst. If it is confirmed that the catalyst has been replaced, it may be inferred that the new catalyst is fully functional. At 336, for the new catalyst, the AC parameter for each of the filters A and B may be reset. For filter A, the assigned AC parameter may be reset to the maximum permissible value for AC parameter while for filter B, the assigned AC parameter may correspond to a first level of catalyst degradation. For example, AC_A may be reset to 1.0 and AC_B may be re-assigned as 0.9. The catalyst health monitoring may then be continued for the new catalyst.

In this way, by using a plurality of model-based filters, catalyst functionality may be continuously monitored and intermediate stages of a catalyst's health may be determined over its entire lifetime. By continuously estimating the current state of the catalyst, engine operating parameters may be suitably adjusted to improve fuel consumption and emissions quality.

Moving on to FIG. 5, an example 500 of catalyst health monitoring based on the roll-down methodology is shown. A preset catalyst activity (AC) parameter defined to depict a current level of catalyst storage capacity of the three-way catalyst (such as catalyst 170 in FIG. 1) may be utilized in the roll-down methodology for catalyst health monitoring.

Two preset AC parameters indicative of a catalyst storage capacity may be assigned to two model-based filters. A first AC parameter (AC₁) may be assigned to a first model-based filter A. For a new catalyst installed in a vehicle, in Setup 1, the first AC parameter assigned to filter A may be set to a maximum value. In this example the value of AC₁ is 1.0. A second AC parameter may be assigned to a second model-based filter B. In Setup 1, the second AC parameter assigned to filter B may correspond to a first level of catalyst degradation (e.g., less than the maximum value of AC parameter). In this example, the value of AC parameter corresponding to first level of catalyst degradation (AC₂) is 0.9.

Air-fuel ratio estimation may be carried out based on input from a plurality of exhaust gas sensors over a time window. Also, an air-fuel ratio expected based on the AC parameters AC₁ and AC₂ corresponding to each of filters A and B may be computed. The measured air-fuel ratio may be compared to the expected air-fuel ratios and a first normalized mean-square error (NMSE₁) may be computer for filter A, and a second normalized mean-square error (NMSE₂) may be computer for filter B. NMSE₁ may then be compared to NMSE₂. If the NMSE₁ is lower than or equal to the NMSE₂, it may be inferred that the AC₁ more accurately represents the current storage capacity of the catalyst and the AC parameters for filter A and filter B may be maintained in Setup 1. Engine operating parameters and initiation of on-board diagnostic (OBD) routines may be adjusted accordingly. If the NMSE₂ is lower than NMSE₁, it may be inferred that the AC₂ more accurately represents the current storage capacity of the catalyst, and that the catalyst storage capacity has degraded to the first level of catalyst degradation level represented by AC₂. Responsive to NMSE₂ being lower than NMSE₁, the AC parameters of the two filters may be updated to Setup 2 based on the roll-down methodology. In Setup 2, the AC parameter for filter A may be lowered to the preset AC parameter of filter B (AC₂) while the AC parameter for filter B may be lowered to a second level of catalyst degradation (AC₃) representative of a second catalyst state that is one level below the first catalyst state. In this example, AC₃ (denoting second level of catalyst degradation) may have a value of 0.75. In addition, engine operating parameters such as fueling, as well as initiation of OBD routines may be adjusted based on the updated functionality of the catalyst.

The updating of the AC parameters for each of filter A and filter B may be repeated iteratively responsive to a difference in the expected air-fuel ratio (for each filter) from the actual (estimated) air-fuel ratio. Normalized mean-square error, NMSE₂ may be computed for filter A based on a comparison between an expected air-fuel ratio (based on AC₂) and estimated air-fuel ratio (based on exhaust gas sensor measurement) while normalized mean-square error, NMSE₃ may be computed for filter B based on a comparison between an expected air-fuel ratio (based on AC₃) and estimated air-fuel ratio. If it is determined that NMSE₂ is lower than or equal to the NMSE₃, it may be inferred that the AC₂ more accurately represents the current storage capacity of the catalyst and the AC parameters for filter A and filter B may be maintained in Setup 2. If NMSE₃ is lower than NMSE₂, it may be inferred that the AC₃ more accurately represents the current storage capacity of the catalyst, and that the catalyst storage capacity has degraded to the second level of catalyst degradation as represented by AC₃. Responsive to NMSE₃ being lower than NMSE₂, the AC parameters of the two filters may be updated to Setup 3 based on the roll-down methodology.

In Setup 3, the AC parameter for filter A may be further lowered to the preset AC parameter of filter B (AC₃) while the AC parameter for filter B may be lowered to a third level of catalyst degradation (AC₄) representative of a third catalyst state that is two levels below the first catalyst state. In this example, AC₄ (denoting third level of catalyst degradation) may have a value of 0.4. Normalized mean-square error, NMSE₃ may be computed for filter A based on a comparison between an expected air-fuel ratio (based on AC₃) and estimated air-fuel ratio while normalized mean-square error, NMSE₄ may be computed for filter B based on a comparison between an expected air-fuel ratio (based on AC₄) and estimated air-fuel ratio. If it is determined that NMSE₃ is lower than or equal to the NMSE₄, it may be inferred that the AC parameters for filter A and filter B may be maintained in Setup 3. If NMSE₄ is lower than NMSE₃, it may be inferred that the AC₄ more accurately represents the current storage capacity of the catalyst, and that the catalyst storage capacity has degraded to the third level of catalyst degradation as represented by AC₄. Also, responsive to NMSE₄ being lower than NMSE₃, the AC parameters of the two filters may be updated to Setup 4 following the roll-down methodology.

In Setup 4, the AC parameter for filter A may be further lowered to the preset AC parameter of filter B (AC₄) while the AC parameter for filter B may be lowered to a fourth level of catalyst degradation (AC₅) representative of a fourth catalyst state that is three levels below the first catalyst state. The fourth level of catalyst degradation is the minimum permissible value (threshold). Once the AC parameter for filter A reaches the threshold value, degradation of the catalyst may be indicated and catalyst replacement may be requested. In this example, AC₅ may have a value of 0.1. Normalized mean-square error, NMSE₄ may be computed for filter A based on a comparison between an expected air-fuel ratio (based on AC₄) and estimated air-fuel ratio while normalized mean-square error, NMSE₅ may be computed for filter B based on a comparison between an expected air-fuel ratio (based on AC₅) and an estimated air-fuel ratio. If it is determined that NMSE₄ is lower than or equal to the NMSE₅, it may be inferred that the catalyst has not yet completely degraded and the AC parameters for filter A and filter B may be maintained in Setup 4. Engine operating parameters may be adjusted based on the current state of catalyst functionality. However, if it is determined that NMSE₅ is lower than NMSE₄, it may be inferred that the catalyst is degraded. Degradation of the catalyst may be indicated by setting a flag or a diagnostic code, or activating a malfunction indicator lamp in order to notify the vehicle operator that the catalyst is degraded and have to be replaced. In response to the indication of catalyst degradation, the controller may adjust the operation of one or more engine actuators to adjust engine operation.

In this example, the values of AC parameters at each Setup decreases non-linearly. However, in another example the values of AC parameters at each Setup may decrease linearly. Once the catalyst is replaced, the AC parameter for filter A may be reset and rolled-down method for catalyst health monitoring may be resumed. In this way, catalyst functionality may be effectively determined at any given time, including a state of partial activity as well as a degree of loss in activity and engine operating parameters may be accordingly adjusted to improve fuel consumption and emissions quality.

FIG. 4 shows an example operating sequence 400 illustrating continual monitoring of an exhaust three-way catalyst functionality and corresponding engine parameter adjustments. The horizontal (x-axis) denotes time and the vertical markers t1-t6 identify significant times in functionality (health) monitoring of the catalyst.

The first plot from the top, line 402, shows variation in engine speed over time. In order to monitor the functionality of the catalyst over its lifetime, two model-based filters, namely filter A and filter B, may be defined each with a pre-set value for the catalyst's activity (AC) parameter. The AC parameter may be defined as a parameter depicting a current level of functionality of the catalyst. For catalyst health monitoring, the AC parameter may decrease monotonically whereas the actual catalyst storage capacity may both increase and decrease based on engine operations. The second plot, line 403, indicates the current AC parameter corresponding to filter A. The line 405 corresponds to the highest AC parameter (e.g. 1.0) as assigned to a fully functional (new) catalyst. The lines 406, 407, 408, and 409 correspond to AC parameters as assigned to a catalyst at different stages of functionality, each state below the fully functional state of catalyst functionality. In one example, line 406 may correspond to 0.9, line 407 may correspond to 0.7, line 408 may correspond to 0.5, and line 409 may correspond to 0.3. The line 404 depicts a threshold value of AC parameter. If the AC parameter corresponding to filter A decreases below the threshold 404, catalyst degradation may be indicated and catalyst replacement may be requested. The third plot, line 410, indicates the current AC parameter corresponding to filter B. The fourth plot, line 412 shows the state of a flag indicating catalyst degradation. The fifth plot, line 414, shows air-fuel ratio as estimated by the exhaust gas sensors (such as exhaust gas oxygen sensor (UEGO) and/or a tailpipe heated gas oxygen sensor (HEGO)). Dotted line 416 shows an updated estimate of air-fuel ratio (AFR) taking into account the current state of catalyst functionality. The sixth plot, line 418, shows a fueling schedule as determined based on the air-fuel ratio estimation from the exhaust gas sensors. Line 420 shows a stoichiometric level for fueling. Dotted line 422 shows an updated fueling schedule taking into account the current state of catalyst functionality.

Prior to time t1, the vehicle speed is observed to increase as the vehicle starts from rest after a period of engine inactivity. At this time, the vehicle is new with a fully functional catalyst. Due to the highest level of catalyst functionality, the AC parameter may be set to a maximum level 405 for the filter A. Filter B may be assigned an AC parameter 406 corresponding to a first level of catalyst degradation (representative of a first catalyst state that is one level below a fully functional catalyst state 405).

During engine operation, the AC parameters corresponding to filters A and B may be continually compared to an AFR estimate from the exhaust gas sensors and a normalized mean-square error (NMSE) may be determined for each of the two filters. The comparison may be carried out over a finite time window. The NMSE estimates for each filter may then be compared to each other. If it is determined that the NMSE for filter A (NMSE_A) is lower than the NMSE for filter B (NMSE_B), it may be inferred that the AC parameter for filter A is the current AC parameter for the catalyst. If it is determined that the NMSE_B is lower than the NMSE_A, the AC parameters of the two filters may be updated based on a roll-down methodology. Following the roll-down methodology, as described below, filter A may be updated with the preset AC parameter setting of filter B and the filter B may be updated with a AC parameter that is one level below its previous setting.

In particular, prior to time t1, the NMSE_A continues to be lower than NMSE_B. Based on the lower error of the first filter, it may be inferred that the catalyst is fully functional and therefore the flag may be maintained in the OFF position. Since the catalyst is fully functional, the AFR estimated by the exhaust gas sensors may be deemed accurate without any requirement for adjustments. Similarly, the fueling schedule as determined from the estimated AFR may be directly used for supplying fuel to the engine.

At time t1, it may be determined that the NMSE_B is lower than the NMSE_A indicating that the catalyst is no longer at its original level of functionality (fully functional). At this stage, the AC parameters corresponding to the two filters may be updated. Specifically, filter A may be assigned AC parameter 406 corresponding to the first level of catalyst degradation whereas filter B may be assigned AC parameter 407 corresponding to a second level of catalyst degradation. In other words, the AC parameter for the first filter is rolled down to the original AC parameter of the second filter, while the AC parameter for the second filter is rolled down to an updated (lower) AC parameter.

Between time t1 and t2, based on the updated AC parameters for filter A and filter B, NMSE_A and NMSE_B may be continually determined and compared to each other. The updated NMSE_A may be higher than NMSE_B and the catalyst may continue to operate with a first level of degradation (where the functionality is one level below that of a fully functional catalyst state). Engine operating parameters may be adjusted based on the first degraded state of the catalyst. During this time, the AFR estimated by the exhaust gas sensors may be erroneous and therefore may be adjusted taking into account the current state of the catalyst. In this example, the adjusted AFR may be lower than the estimated AFR. Correspondingly, the fueling schedule may be updated taking into account the adjusted AFR. In particular, the fuel provided may be higher than the fuel calculated based on the estimated AFR. Also, initiation of on-board diagnostic routines may be adjusted based on the current state of the catalyst, allowing for an improvement in the completion rate of the routines. Since during this time, as the catalyst continues to be functional, the flag is maintained in the OFF position.

At time t2, it may again be determined that the NMSE_B is lower than the NMSE_A, thereby indicating a further deterioration in the health of the catalyst. Based on the current indication of catalyst deterioration, filter A may be rolled to AC parameter 407 corresponding to the second level of catalyst degradation while filter B may be rolled-down to AC parameter 408 corresponding to a third level of catalyst degradation. In the present example, it may be inferred the current catalyst functionality at this state is two levels below that of a fully functional catalyst state.

Between time t2 and t3, based on the updated AC parameters for filter A and filter B, NMSE_A and NMSE_B may be continually determined and compared to each other. The updated NMSE_A may be higher than NMSE_B and the catalyst may continue to operate with functionality two levels below that of a fully functional catalyst state. During this time, engine operating parameters and initiation of on-board diagnostics may be adjusted based on the second degraded state of the catalyst. The AFR estimate may be continually adjusted taking into account the current state of the catalyst. In this example, the adjusted AFR may be lower than the estimated AFR. Correspondingly, the fueling schedule may be updated taking into account the adjusted AFR. The fuel provided may be higher/lower than the fuel calculated based on the estimated AFR.

At time t3, it may again be determined that the NMSE_B is lower than the NMSE_A and that the health of the catalyst has deteriorated further. Consequently the AC parameters corresponding to the two filters may be updated. Filter A may be rolled down to AC parameter 408 corresponding to the third level of catalyst degradation whereas filter B may be rolled down to AC parameter 409 corresponding to a fourth level of catalyst degradation. The current catalyst functionality at this state is three levels below that of a fully functional catalyst state. However, this level of catalyst functionality is higher than the threshold AC parameter level 404 corresponding to catalyst degradation.

Between time t3 and t4, based on the current AC parameters for filter A and filter B, NMSE_A and NMSE_B may be continually determined and compared to each other. The updated NMSE_A may be higher than NMSE_B and the catalyst may continue to operate with functionality three levels below that of a fully functional catalyst state. Engine operating parameters and on-board diagnostics may be continued to be adjusted based on the third degraded state of the catalyst. The AFR estimate and fueling schedule may be suitably adjusted taking into account the current state of the catalyst.

At time t4, it may again be determined that the NMSE_B is lower than the NMSE_A, indicating that the catalyst functionality has further deteriorated. Filter A may be assigned AC parameter 408 corresponding to the fourth level of catalyst degradation which is lower than the AC parameter corresponding to threshold 404. Since at this stage the catalyst is inferred to be degraded (lowest level of functionality), the roll-down methodology for catalyst functionality monitoring may be suspended, and no further AC parameter may not be assigned to the filter B. At this time, based on the lower than threshold catalyst state, catalyst degradation may be indicated. The indicating may include setting a flag or a diagnostic code, or activating a malfunction indicator lamp in order to notify the vehicle operator that the catalyst is degraded and needs to be replaced. Between time t4 and t5, the vehicle may be continued to be operated with the degraded catalyst. Engine operating parameters including AFR and fueling schedule may be continued to be adjusted taking into account the degraded condition of the catalyst. On-board diagnostics may be updated based on compensative measures accounting for the degraded catalyst state.

At time t5, the vehicle engine is switched off. Between time t5 and t6, the vehicle may be taken to a service center wherein the degraded three-way exhaust catalyst may be replaced with a new fully functional catalyst. Once the new catalyst is installed, the AC parameter for each of the filters A and B may be reset. For filter A, the assigned AC parameter may correspond to the maximum permissible value for AC parameter (405) while for filter B, the assigned AC parameter may correspond to a first level of catalyst degradation (406). The catalyst functionality monitoring may then be continued for the new catalyst.

It will be appreciated that while the depicted example shows the AC parameter for the filters being rolled-down linearly/step-wise (one level down at each iteration), this is not meant to be limiting and that in alternate examples, the AC parameter for the filters may be rolled-down non linearly, such as by multiple levels at each iteration.

One example method comprises, adjusting engine fuel injection responsive to sensor feedback and a first estimate of catalyst storage capacity determined during engine operation, the first estimate increased and decreased responsive to conditions; and indicating catalyst degradation responsive to a second estimate of catalyst storage capacity estimated during engine operation, the second estimate only decreased (not increasing) responsive to conditions. In the preceding example, additionally or optionally, the first estimate is based on a measured air-fuel ratio, and wherein the second estimate is based on each of a first modeled catalyst activity parameter relative to the measured air-fuel ratio and a second modeled catalyst activity parameter relative to the measured air-fuel ratio. In any or all of the preceding examples, additionally or optionally, the first modeled catalyst activity parameter is initially set to an upper limit of catalyst functionality, and wherein the second modeled catalyst activity parameter is initially set to a first level of degradation in catalyst functionality. In any or all of the preceding examples, the measured air-fuel ratio is additionally or optionally based on an output of a plurality of exhaust gas sensors, collected over a time window. In any or all of the preceding examples, additionally or optionally, indicating catalyst degradation includes estimating a first normalized mean square error between the measured air-fuel ratio and a first estimated air-fuel ratio, computed based on first model catalyst activity parameter, estimating a second normalized mean square error between the measured air-fuel ratio and a second estimated air-fuel ratio, computed based on second model catalyst activity parameter;, comparing the first normalized mean square error to the second normalized mean square error, and responsive to the second normalized mean square error being lower than the first normalized mean square error, indicating catalyst degradation at the first level, and responsive to the second normalized mean square error being higher than the first normalized mean square error, indicating catalyst functionality at the upper limit. Any or all of the preceding examples, further comprises, additionally or optionally, responsive to the indicating catalyst degradation at the first level, updating the first modeled catalyst activity parameter to the first level of degradation in catalyst functionality, and updating the second modeled catalyst activity parameter to a second level of degradation in catalyst functionality, the second level representing a higher level of degradation than the first level. Any or all of the preceding examples, further comprises, additionally or optionally, iteratively updating the estimate for the first normalized mean square error between the measured air-fuel ratio and the first estimated air-fuel ratio and the estimate for second normalized mean square error between the measured air-fuel ratio and the second estimated air-fuel ratio, iteratively comparing the updated first normalized mean square error to the updated second normalized mean square error, iteratively updating the first modeled catalyst activity parameter and the second modeled catalyst activity parameter based on the first normalized mean square error relative to the second normalized mean square error, and iteratively updating the second estimate of catalyst storage capacity. Any or all of the preceding examples, further comprises, additionally or optionally, adjusting a plurality of engine operating parameters and one or more on-board diagnostic routines based on the second estimate of catalyst storage capacity, wherein the engine operating parameters include air-fuel ratio, and fueling schedule.

Another example method comprises comparing a first error between a measured air-fuel ratio and a first estimated exhaust air-fuel ratio, computed based on a first model-based filter having a first activity parameter for an exhaust catalyst to a second error between the measured air-fuel ratio and a second estimated exhaust air-fuel ratio, computed based on a second model-based filter having a second modeled activity parameter for the exhaust catalyst; decreasing the first activity parameter as the first error exceeds the second error; and indicating catalyst degradation responsive to the first activity parameter falling below a threshold. In the preceding example, additionally or optionally, the first error includes a normalized mean-square error between the measured air-fuel ratio and the first estimated exhaust air-fuel ratio and the second error includes a normalized mean-square error between the measured air-fuel ratio and the second estimated exhaust air-fuel ratio. Any or all of the preceding examples further comprises, additionally or optionally, initially setting the first activity parameter of the first filter to a value corresponding to an upper limit of catalyst functionality, and the second activity parameter of the second filter to a value corresponding to a first level of degradation in catalyst functionality. In any or all of the preceding examples, initially setting additionally or optionally includes setting each of the first activity parameter and the second activity parameter responsive to installation of an exhaust catalyst in the engine. In any or all of the preceding examples, additionally or optionally, decreasing the first activity parameter includes resetting the first activity parameter of the first filter to the second activity parameter of the second filter, the method further comprises, while resetting the first activity parameter, decreasing the second activity parameter of the second filter to a value corresponding to a second level of degradation in catalyst functionality, the second level higher than the first level, and indicating a current level of catalyst functionality based on a current first activity parameter of the first filter. Any or all of the preceding examples further comprises, additionally or optionally, adjusting an air-fuel ratio estimate, and fueling schedule based on an estimated air-fuel ratio and the first model-based filter.

In yet another example, an engine system comprises an exhaust pipe including a three-way catalyst; a first exhaust gas sensor coupled to the exhaust pipe upstream of the three-way catalyst; a second exhaust gas sensor coupled to the exhaust pipe downstream of the three-way catalyst; a fuel injector for injecting fuel into an engine cylinder; and a controller with computer readable instructions stored on non-transitory memory for: assigning activity parameters to each of a first filter and a second filter associated with an exhaust catalyst storage capacity; iteratively updating an estimated exhaust catalyst storage capacity based on error associated with each of the first filter and the second filter; and adjusting fuel injection based on the updated estimated exhaust catalyst storage capacity. In the preceding example, additionally or optionally, assigning activity parameters to each of the first filter and second filter includes initially assigning a first activity parameter of the first filter to the exhaust catalyst storage capacity corresponding to an upper limit of catalyst functionality, and initially assigning a second activity parameter of the second filter to the exhaust catalyst storage capacity corresponding to a first level of degradation in catalyst functionality. In any or all of the preceding examples, additionally or optionally, the iteratively updating includes rolling down each of the first activity parameter and the second activity parameter based on a comparison between each of the first activity parameter and the second activity parameter and an estimated air-fuel ratio, over a time window, and wherein the first and second activity parameters are not increased responsive to the comparison. In any or all of the preceding examples, additionally or optionally, rolling down each of the first and second activity parameter includes: estimating each of a first error between the estimated air-fuel ratio, and a first computed air-fuel ratio based on the first activity parameter and a second error between the estimated air-fuel ratio and a second computed air-fuel ratio based on the second activity parameter; responsive to the first error lower than the second error, maintaining each of the first activity parameter and the second activity parameter; responsive to the second error lower than the first error, rolling down the first activity parameter to a value of the second activity parameter while rolling down the second activity parameter to a value corresponding to a second level of degradation in catalyst functionality, the second level higher than the first level; and updating the estimated exhaust catalyst storage capacity based on the rolling down of the first activity parameter. Any or all of the preceding examples further comprises, additionally or optionally, iteratively updating until a rolled down value of the first activity parameter reaches a threshold, and then indicating catalyst degradation; and in response to replacement of the exhaust catalyst, resetting the first activity parameter to the upper limit of catalyst functionality.

In this way, by designing a monotonically decreasing activity parameter exclusively usable for catalyst health monitoring, catalyst functionality monitoring may be continuously tracked. By utilizing two model-based filters, intermediate stages of a catalyst's health may be determined over its entire lifetime. By utilizing a roll-down methodology, it is not only possible to detect a completely degraded catalyst but also to determine the functionality of the catalyst at any given time. The technical effect of using the model-based roll-down methodology for catalyst health monitoring is that catalyst activity may be continually tracked without having to wait for specific engine conditions such a DFSO event which may not take place over a prolonged period of operation (based on engine operating conditions). By continuously estimating a current state of the catalyst, engine operating parameters may be suitably adjusted to improve fuel consumption and emissions quality. In addition, initiation of on-board diagnostics may be continually adjusted to compensate for a current state of the catalyst, allowing for an increased completion rate of the diagnostic routines.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
adjusting engine fuel injection responsive to sensor feedback and a first estimate of catalyst storage capacity determined during engine operation, the first estimate increased and decreased responsive to conditions; and
indicating catalyst degradation responsive to a second estimate of catalyst storage capacity estimated during engine operation, the second estimate only decreased responsive to conditions.

2. The method of claim 1, wherein the first estimate is based on a measured air-fuel ratio, and wherein the second estimate is based on each of a first modeled catalyst activity parameter relative to the measured air-fuel ratio and a second modeled catalyst activity parameter relative to the measured air-fuel ratio.

3. The method of claim 2, wherein the first modeled catalyst activity parameter is initially set to an upper limit of catalyst functionality, and wherein the second modeled catalyst activity parameter is initially set to a first level of degradation in catalyst functionality.

4. The method of claim 2, wherein the measured air-fuel ratio is based on an output of a plurality of exhaust gas sensors, collected over a time window.

5. The method of claim 2, wherein indicating catalyst degradation includes estimating a first normalized mean square error between the measured air-fuel ratio and a first estimated air-fuel ratio, computed based on first model catalyst activity parameter, estimating a second normalized mean square error between the measured air-fuel ratio and a second estimated air-fuel ratio, computed based on second model catalyst activity parameter; comparing the first normalized mean square error to the second normalized mean square error, and responsive to the second normalized mean square error being lower than the first normalized mean square error, indicating catalyst degradation at the first level, and responsive to the second normalized mean square error being higher than the first normalized mean square error, indicating catalyst functionality at the upper limit.

6. The method of claim 5, further comprising, responsive to the indicating catalyst degradation at the first level, updating the first modeled catalyst activity parameter to the first level of degradation in catalyst functionality, and updating the second modeled catalyst activity parameter to a second level of degradation in catalyst functionality, the second level representing a higher level of degradation than the first level.

7. The method of claim 6, further comprising, iteratively updating the estimate for the first normalized mean square error between the measured air-fuel ratio and the first estimated air-fuel ratio and the estimate for second normalized mean square error between the measured air-fuel ratio and the second estimated air-fuel ratio, iteratively comparing the updated first normalized mean square error to the updated second normalized mean square error, iteratively updating the first modeled catalyst activity parameter and the second modeled catalyst activity parameter based on the first normalized mean square error relative to the second normalized mean square error, and iteratively updating the second estimate of catalyst storage capacity.

8. The method of claim 1, further comprising, adjusting a plurality of engine operating parameters and one or more on-board diagnostic routines based on the second estimate of catalyst storage capacity, wherein the engine operating parameters include air-fuel ratio, and fueling schedule.

9. An engine method, comprising:
comparing a first error between a measured air-fuel ratio and a first estimated exhaust air-fuel ratio, computed based on a first model-based filter having a first activity parameter for an exhaust catalyst to a second error between the measured air-fuel ratio and a second estimated exhaust air-fuel ratio, computed based on a second model-based filter having a second modeled activity parameter for the exhaust catalyst;
decreasing the first activity parameter as the first error exceeds the second error; and
indicating catalyst degradation responsive to the first activity parameter falling below a threshold.

10. The method of claim 9, wherein the first error includes a normalized mean-square error between the measured air-fuel ratio and the first estimated exhaust air-fuel ratio and the second error includes a normalized mean-square error between the measured air-fuel ratio and the second estimated exhaust air-fuel ratio.

11. The method of claim 9 further comprising, initially setting the first activity parameter of the first filter to a value corresponding to an upper limit of catalyst functionality, and the second activity parameter of the second filter to a value corresponding to a first level of degradation in catalyst functionality.

12. The method of claim 10, wherein initially setting includes setting each of the first activity parameter and the second activity parameter responsive to installation of an exhaust catalyst in the engine.

13. The method of claim 9, wherein decreasing the first activity parameter includes resetting the first activity parameter of the first filter to the second activity parameter of the second filter, the method further comprising, while resetting the first activity parameter, decreasing the second activity parameter of the second filter to a value corresponding to a second level of degradation in catalyst functionality, the second level higher than the first level, and indicating a current level of catalyst functionality based on a current first activity parameter of the first filter.

14. The method of claim 10, further comprising, adjusting an air-fuel ratio estimate, and fueling schedule based on an estimated air-fuel ratio and the first model-based filter.

15. The method of claim 9, wherein the estimation of exhaust air-fuel includes estimating air-fuel ratio from each of an exhaust oxygen sensor coupled upstream of the catalyst and an exhaust oxygen sensor coupled downstream of the catalyst, over a time window, and estimating an average air-fuel ratio based on an output from each of the two exhaust oxygen sensors over the time window.

16. An engine system, comprising:
an exhaust pipe including a three-way catalyst;
a first exhaust gas sensor coupled to the exhaust pipe upstream of the three-way catalyst;
a second exhaust gas sensor coupled to the exhaust pipe downstream of the three-way catalyst;
a fuel injector for injecting fuel into an engine cylinder; and
a controller with computer readable instructions stored on non-transitory memory for:
assigning activity parameters to each of a first filter and a second filter associated with an exhaust catalyst storage capacity;
iteratively updating an estimated exhaust catalyst storage capacity based on error associated with each of the first filter and the second filter; and
adjusting fuel injection based on the updated estimated exhaust catalyst storage capacity.

17. The method of claim 16, wherein assigning activity parameters to each of the first filter and second filter includes initially assigning a first activity parameter of the first filter to the exhaust catalyst storage capacity corresponding to an upper limit of catalyst functionality, and initially assigning a second activity parameter of the second filter to the exhaust catalyst storage capacity corresponding to a first level of degradation in catalyst functionality.

18. The system of claim 17, wherein the iteratively updating includes rolling down each of the first activity parameter and the second activity parameter based on a comparison between each of the first activity parameter and the second activity parameter and an estimated air-fuel ratio, over a time window, and wherein the first and second activity parameters are not increased responsive to the comparison.

19. The system of claim 18, wherein rolling down each of the first and second activity parameter includes:
estimating each of a first error between the estimated air-fuel ratio, and a first computed air-fuel ratio based on the first activity parameter and a second error between the estimated air-fuel ratio and a second computed air-fuel ratio based on the second activity parameter;
responsive to the first error lower than the second error, maintaining each of the first activity parameter and the second activity parameter;
responsive to the second error lower than the first error, rolling down the first activity parameter to a value of the second activity parameter while rolling down the second activity parameter to a value corresponding to a second level of degradation in catalyst functionality, the second level higher than the first level; and
updating the estimated exhaust catalyst storage capacity based on the rolling down of the first activity parameter.

20. The system of claim 19, further comprising, iteratively updating until a rolled down value of the first activity parameter reaches a threshold, and then indicating catalyst degradation; and
in response to replacement of the exhaust catalyst, resetting the first activity parameter to the upper limit of catalyst functionality.
